(19) United States
(12) Patent Application Publication
(10) Pub. No.: US 2005/0097543 A1
(43) Pub. Date: May 5, 2005

(54) Electronic apparatus and embedded software updating method

(75) Inventor: Noriyuki Hirayama, Fuchu-shi (JP)

Correspondence Address: Finnegan, Henderson, Farabow,;Garrett & Dunner, L.L.P., 1300 I Street, N.W., Washington, DC, 20005-3315, US

(73) Assignee: KABUSHIKI KAISHA TOSHIBA

(21) Appl. No.: 10/952,910

(22) Filed: Sep. 30, 2004

(30) Foreign Application Priority Data
Oct. 30, 2003 (JP) 2003-371096

(51) Int. Cl. G06F 9/44

(52) U.S. Cl. 717/168; 717/173; 717/174

(57) ABSTRACT

An electronic apparatus executes communication with a serer via a network. The device includes a informing unit configured to inform the server of software configuration information indicative of a current configuration of embedded software that is installed in the electronic apparatus, to request update list information from the server, the update list information indicating of a latest program module that can be installed in the electronic apparatus and another program module that is necessary for execution of the latest program module, a downloading unit configured to download from the server a plurality of program modules including the latest program module and the another program module, based on the update list information that is transmitted from the server, and an updating unit configured to execute an updating process for updating the embedded software, using the downloaded plurality of program modules.

### CROSS-REFERENCE TO RELATED APPLICATIONS

This application is based upon and claims the benefit of priority from prior Japanese Patent Application No. 2003-371096, filed Oct. 30, 2003, the entire contents of which are incorporated herein by reference.

### BACKGROUND OF THE INVENTION

1. Field of the Invention

The present invention relates to an electronic apparatus that is operated by embedded software, and a method of updating the embedded software.

2. Description of the Related Art

In recent years, a variety of electronic apparatus, such as a video recorder, a TV and a network device, have been developed as so-called information appliances. These electronic apparatus are designed to operate under control of embedded software that is preinstalled in them.

By updating the embedded software, these electronic apparatus are capable of overcoming operational drawbacks and having new additional functions.

Jpn. Pat. Appln. KOKAI Publication No. 2001-202234 discloses a technique of downloading from a center to a terminal only a different component between a new-version program module and an old-version program module.

In Jpn. Pat. Appln. KOKAI Publication No. 2001-202234, however, no consideration is given to a dependency relationship between program modules. Embedded software is composed of various program modules. In usual cases, there is dependency between program modules. In order to execute a program module, it is necessary that some other program module be already installed in the electronic apparatus. It is very difficult, however, for the user himself/herself to select a program module to be downloaded, taking into account the dependency relationship between program modules.

A new scheme, therefore, is necessary in order to automatically download a program module group, which is necessary for updating embedded software, in consideration of the dependency between program modules.

### BRIEF SUMMARY OF THE INVENTION

According to an embodiment of the present invention, there is provided an electronic apparatus capable of executing communication with a serer via a network, the electronic apparatus comprising: a informing unit configured to inform the server of software configuration information indicative of a current configuration of embedded software that is installed in the electronic apparatus, to request update list information from the server, the update list information indicating of a latest program module that can be installed in the electronic apparatus and another program module that is necessary for execution of the latest program module; a downloading unit configured to download from the server a plurality of program modules including the latest program module and the another program module, based on the update list information that is transmitted from the server; and an updating unit configured to execute an updating process for updating the embedded software, using the downloaded plurality of program modules.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the structure of a system including an electronic apparatus according to an embodiment of the present invention and a module providing server;

FIG. 2 shows an example of a module management database that is managed by the module providing server in the system shown in FIG. 1;

FIG. 3 shows an example of an individual information management database that is managed by the module providing server in the system shown in FIG. 1;

FIG. 4 is a flow chart illustrating an example of the procedure of an initial setting process in the system shown in FIG. 1;

FIG. 5 is a flow chart illustrating a part of the procedure of an embedded software updating process in the system shown in FIG. 1;

FIG. 6 is a flow chart illustrating the other part of the procedure of the embedded software updating process in the system shown in FIG. 1;

FIG. 7 is a flow chart illustrating an example of the procedure of a download list preparation process, which is executed in the embedded software updating process in the system shown in FIG. 1;

FIG. 8 shows an example of version information that is sent from an electronic apparatus to a server in the system shown in FIG. 1;

FIG. 9 shows an example of update list information that is sent from the server to the electronic apparatus in the system shown in FIG. 1;

FIG. 10 shows an example of an update notice dialog that is used in the system of FIG. 1;

FIG. 11 shows an example of a module selection dialog that is used in the system of FIG. 1;

FIG. 12 shows an example of a non-operative period detection process that is executed by the electronic apparatus in the system of FIG. 1;

FIG. 13 shows another example of the individual information management database that is managed by the module providing server in the system shown in FIG. 1;

FIG. 14 is a flow chart illustrating an example of a procedure for changing a to-be-downloaded program module in accordance with a membership kind in the system shown in FIG. 1;

FIG. 15 shows an example of a system that is formed by adding a settlement system to the system shown in FIG. 1;

FIG. 16 shows an example of a module purchase screen that is used in the system of FIG. 1;

FIG. 17 is a flow chart illustrating an example of the procedure of a module purchase process that is executed by the system of FIG. 1; and

FIG. 18 shows a system configuration wherein the system of FIG. 1 is provided with a plurality of module providing servers.

### DETAILED DESCRIPTION OF THE INVENTION

An embodiment of the present invention will now be described with reference to the accompanying drawings.

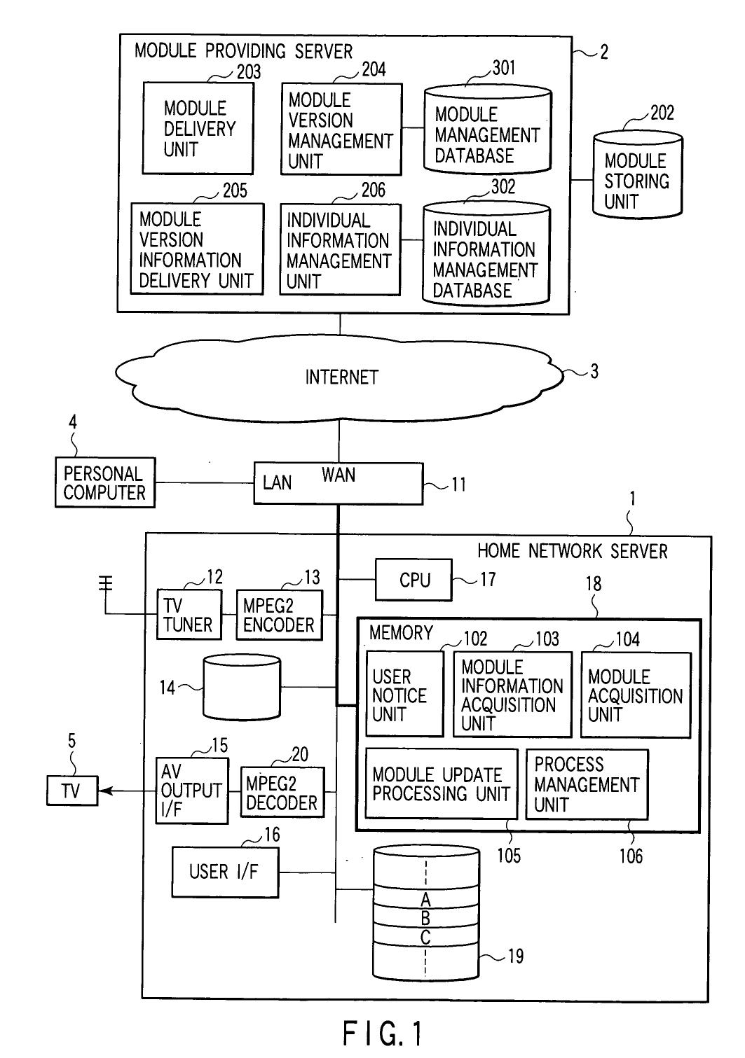

FIG. 1 shows the structure of an electronic apparatus according to an embodiment of the invention. The electronic apparatus incorporates an embedded system that includes a microprocessor. The electronic apparatus operates according to embedded software that is installed therein. The embedded software is software that controls the operation of the embedded system, that is, the operation of the electronic apparatus. This electronic apparatus is realized as a home network server 1.

The home network server 1 is an electronic apparatus that is equipped with a communication function and a video recorder function. Upon request from a user, the home network server 1 provides the user with viewing/listening services of broadcast program data. In addition, the home network server 1 is connected to an external network, such as the Internet 3, via a broadband router 11. The broadband router 11 is connected to a personal computer 4 via a wired LAN (Wide Area Network) or a wireless LAN. The broadband router 11 executes data transfer between the household personal computer 4 and various Web servers on the Internet 3.

The home network server 1 has a function of receiving and recording broadcast program data such as TV program data. The home network server 1 is capable of transmitting to the personal computer 4, via the wired/wireless LAN, broadcast program data that is currently being broadcast, or broadcast program data that is already recorded in a hard disk drive 14 within the home network server 1. In addition, the home network server 1 has a function of recording broadcast program data, which is designated by programmed recording information that is input by the user.

The operation of the home network server 1 is controlled by embedded software (kernel, drivers, libraries, applications) that is installed in the home network server 1. The home network server 1 has a function of automatically updating the embedded software. The automatic update of embedded software is executed using communication between the home network server 1 and a module providing server 2 on the Internet 3. The module providing server 2 is realized by, e.g. an HTTP (Hyper Text Transfer Protocol) server. The communication between the module providing server 2 and home network server 1 is executed according to a communication protocol defined by HTTP. Needless to say, a dedicated communication protocol, which is determined between the module providing server 2 and home network server 1, may be used.

The broadband router 11 is a device functioning as a router. The broadband router 11 includes a WAN (Wide Area Network) connector and a LAN connector. The WAN connector is connected to the Internet 3 via a communication line such as ADSL or CATV. The LAN connector is connected to the personal computer 4 via a wired LAN within the home. The broadband router 11 further includes a wireless LAN device, and the broadband router 11 can wirelessly be connected to the personal computer 4. The home network server 1 is also connected to the broadband router 11 via the wired LAN or wireless LAN.

The broadband router 11 executes data transfer between a desired Web server on the Internet 3 and each of the personal computer 4 and home network server 11. Further, the broadband router 11 has a function of transmitting broadcast program data, which is received by the home network server 1, to the personal computer 4. The home network server 1 may have the function of the broadband router 11.

The home network server 1 includes a TV tuner 12, an MPEG2 (MPEG: Moving Picture Experts Group) encoder 13, a hard disk drive 14, an audio/video (AV) output interface unit (AV output I/F) 15, a user interface unit (user I/F) 16, a CPU (Central Processing Unit) 17, a memory 18, a hard disk drive 19 and an MPEG2 decoder 20.

The TV tuner 12 is connected to a TV antenna. The TV tuner 12 is a device that executes reception of broadcast program data such as TV broadcast program data. The TV tuner 12 receives broadcast program data of a channel that is designated by the user. The MPEG2 encoder 13 compression-encodes broadcast program data that is received by the TV tuner 12. The hard disk drive 14 is a storage device that stores broadcast program data. The hard disk drive 14 stores broadcast program data that is compression-encoded by the MPEG2 encoder 13.

The AV output I/F 15 outputs broadcast program data, which is stored in the hard disk drive 14, to an external AV device such as a TV receiver 5. Since the broadcast program data stored in the hard disk drive 14 is compression-encoded, the broadcast program data is decoded by the MPEG2 decoder 20 and then output to the external AV device via the AV output I/F 15. The user I/F 16 is a device that interacts with the user by means of GUI (Graphical User Interface). The user I/F 16 includes an input device that inputs an operation request from the user, and an output device that causes a display device, which is provided on the home network server 1, to display an operation screen.

The operation screen may be displayed on an external display device, such as TV receiver 5, through the AV output I/F 15. In this case, while viewing the operation screen displayed on the TV receiver 5, the user can operate an infrared remote-control unit, thereby issuing an operation request to the home network server 1. Alternatively, the operation screen may be displayed on the personal computer 4 via the broadband router 11 and wired/wireless LAN. In this case, while viewing the operation screen displayed on the display device of the personal computer 4, the user can operate the personal computer 4, thereby issuing an operation request to the home network server 1 via the wired/wireless LAN.

The CPU 17 is a processor that controls the operation of the home network server 1 and executes embedded software. The embedded software includes a plurality of programs, that is, a kernel, drivers, libraries, and applications. Further, in this embodiment, the embedded software includes, as program modules for realizing an automatic update function for automatically updating the embedded software, a user notice unit 102, a module information acquisition unit 103, a module acquisition unit 104, a module update process unit 105 and a process management unit 106. The CPU 17 executes the user notice unit 102, module information acquisition unit 103, module acquisition unit 104, module update process unit 105 and process management unit 106, thereby executing a process for automatically updating the embedded software. The update of the embedded software is executed in units of a program module. Each program module is a program group (also known as “software package”) for implementing one function, and the program group includes at least one program.

The user notice unit 102 notifies the user of home network server 1 of various information through the user interface unit 16. The module information acquisition unit 103 notifies the module providing server 2 of software configuration information that is indicative of the current configuration of the embedded software, and requests from the module providing server 2 an update list information that indicates latest program modules, which can be installed in the home network server 1, and other program modules that are necessary for executing the latest program modules. The software configuration information represents program names and version numbers of the program modules that constitute the embedded software.

Based on the update list information that is sent from the module providing server 2, the module acquisition unit 104 downloads from the module providing server 2 a program module group that includes latest program modules and program modules necessary for executing the latest program modules. Using the program module group that is downloaded from the module providing server 2, the module update process unit 105 executes an update process for updating the embedded software. The process management unit 106 has functions of managing the state of each program (each process) of the embedded software and starting and stopping each of the kernel and applications. Application programs included in the embedded software have functions of executing, e.g. a process of recording and reproducing broadcast program data.

The module providing server 2 is a server computer for providing a latest program module group to the home network server 1. The module providing server 2 includes a module storing unit 202. The module storing unit 202 is a storage device that stores version-upgraded program modules that are applicable to the embedded software. The module providing server 2 further includes a module delivery unit 203, a module version management unit 204, a module version information delivery unit 205 and an individual information management unit 206. The module delivery unit 203, module version management unit 204, module version information delivery unit 205 and individual information management unit 206 are realized as programs that are executed by the module providing server 2.

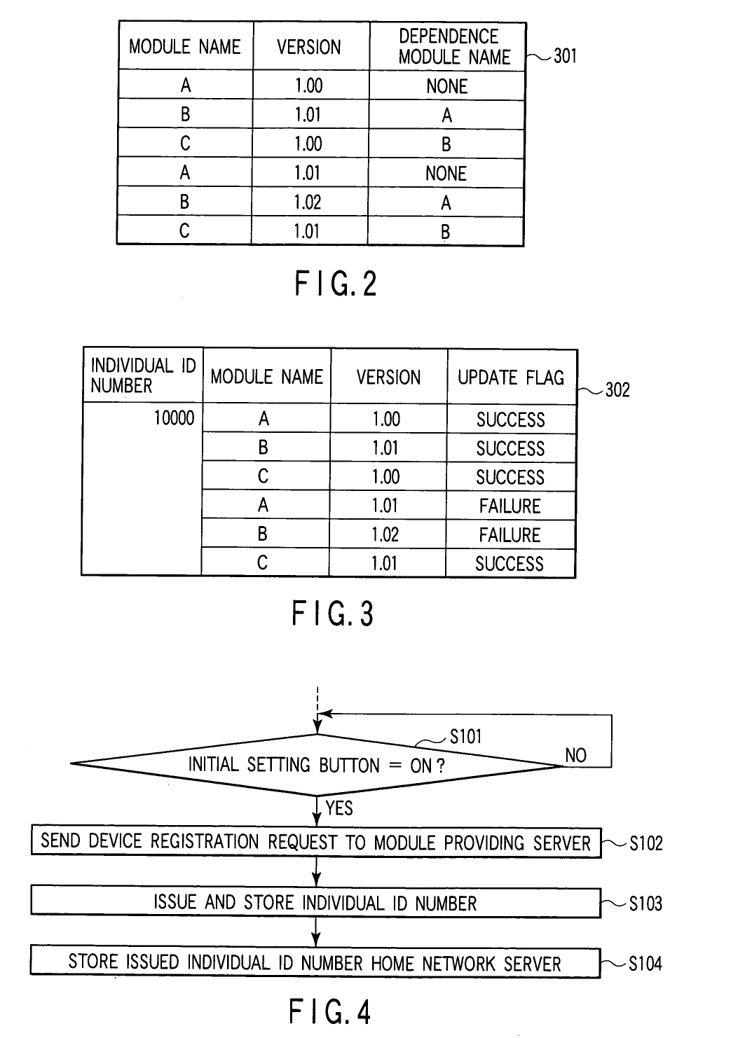

The module delivery unit 203 has a function of delivering upgraded program modules to the home network server 1 in response to a download request from the home network server 1. Using a module management database 301, the module version management unit 204 manages the version of each program module that is stored in the module storing unit 202. The module management database 301, as shown in FIG. 2, manages three attributes, that is, a module name, a version number and a “dependence” module, of each program module that is stored in the module storing unit 202. The “dependence” module, in this context, means a program module that is needed when some program module is to be executed.

The module version information delivery unit 205 has a function of delivering to the home network server 1 update list information that indicates latest program modules, which can be installed in the home network server 1, and other program modules (dependence modules) that are necessary for executing the latest program modules. Using an individual information management database 302, the individual information management unit 206 manages a history of updates of program modules by the home network server 1. The module providing server 2 is shared by a plurality of home network servers 1 that are connected to the Internet 3. The individual information management unit 206 thus manages the update history of each program module in association with each home network server.

As is shown in FIG. 3, the individual information management database 302 manages, in association with each of inherent individual identification numbers (also known as “device IDs”) of home network servers, the module name and version number of a program module that is downloaded in the home network server, and an update flag relating to the program module. The update flag is set at a value indicative of update failure, when the program module is downloaded in the home network server 1. The update flag is changed to a value indicative of update success, in response to a notice from the home network server 1 to the effect that the update of the program module is successfully completed.

Next, a program module updating procedure is described.

An initial setting process needs to be executed prior to executing the program module updating function of the home network server 1. The initial setting process is a device registration process for registering the individual identification number of the home network server 1 in the module providing server 2.

FIG. 4 is a flow chart illustrating the procedure of the initial setting process.

For example, if the user of the home network server 1 presses an initial setting button that is disposed on the operation screen displayed by the user interface 16 (YES in step S101), the CPU 17 of the home network server 1 establishes connection to the module providing serer 2 via the Internet 3 and sends a device registration request to the module providing server 2 (step S102). Responding to the device registration request sent from the home network server 1, the individual information management unit 206 of the module providing server 2 issues an individual identification number for uniquely identifying the home network server 1 and stores the individual identification number in the individual information management database 302 (step S103). Then, the individual information management unit 206 sends the issued individual identification number to the home network server 1. The CPU 17 of the home network server 1 stores in the hard disk drive 19 the individual identification number sent from the module providing server 2.

When the software developer of the embedded software upgrades the versions of program modules (module A, module B, module C, . . . ) of the embedded software, the software developer packages the version-upgraded program modules in a file format of, e.g. RPM (RedHat Package Manager) and stores the packaged modules in the module storing unit 202 of the module providing server 2. The version-upgrading aims at correction of bugs in program modules, enhancement of performance, enhancement of functions, etc. When the software developer packages program modules, signature may be added to clarify the identity of the software developer.

The software developer stores the new-version program module in the module storing unit 202 and registers the module name, version number and dependence module name of the new-version program module in the module management database 301.

Assume that a module B is necessary in order to execute a module C, and a module A is necessary in order to execute the module B. In this case, as shown in FIG. 2, the module B is registered as a dependence module associated with the module C in the module management database 301, and the module A is registered as a dependence module associated with the module B.

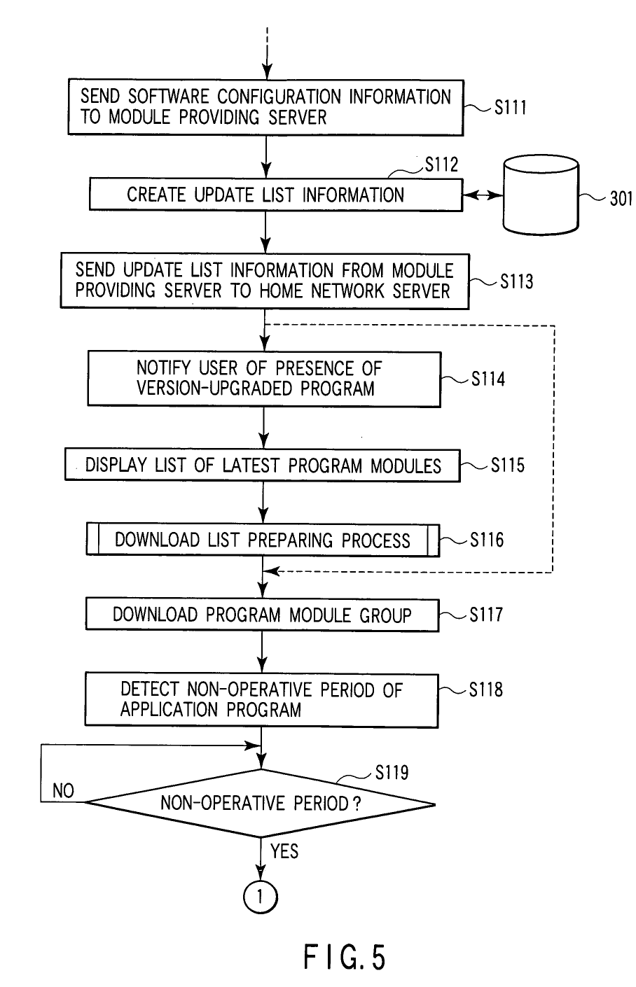

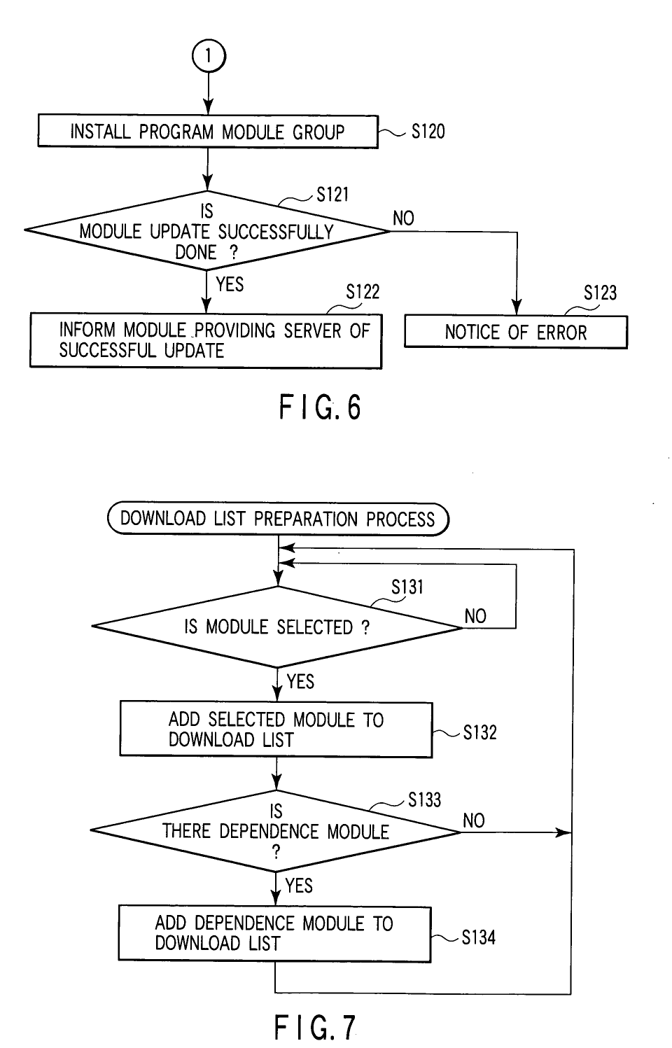

Referring now to flow charts of FIGS. 5 and 6, a description is given of a specific procedure that is executed to update the embedded software.

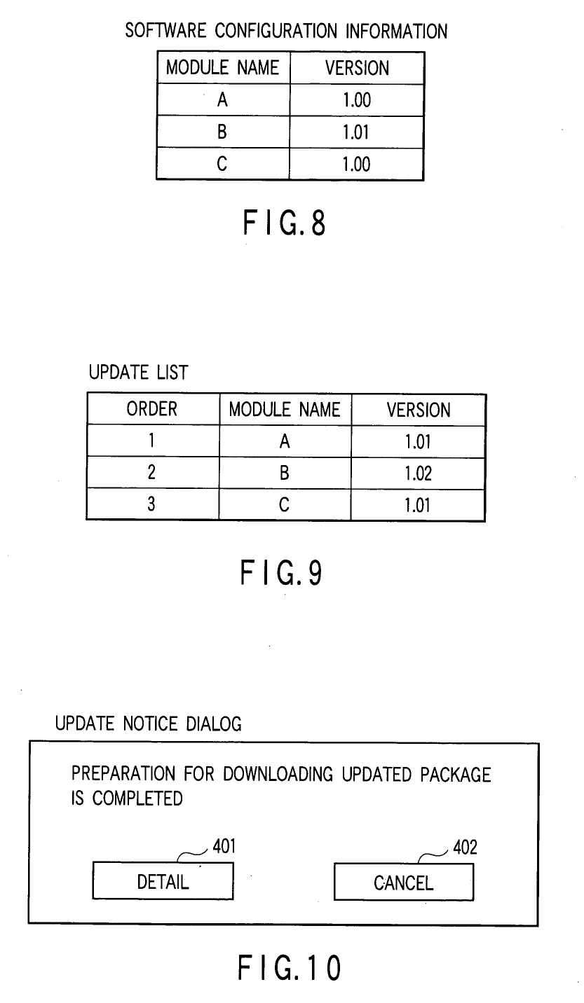

The module information acquisition unit 103 of the embedded software periodically transmits to the module providing server 2 the individual identification number of home network server 1 and the software configuration information as an update list information acquisition request. Thereby, the module information acquisition unit 103 requests update list information from the module providing server 2 (step S111). In step S111, the module information acquisition unit 103 first collects module names and version numbers of program modules that are currently installed in the hard disk drive 19. The module names and version numbers of the program modules that indicate the current configuration of the embedded software may be managed as a database within the embedded software. As is shown in FIG. 8, the software configuration information, which is reported from the module information acquisition unit 103 to the module providing server 2, is formed of a list that indicates the module names and version numbers of the program module group that constitutes the embedded software. The software configuration information is reported to the module providing server 2, for example, at a fixed time on a daily basis. In order to prevent concurrence of reporting from a plurality of home network servers, each home network server may report to the module providing server 2 the software configuration information corresponding to its own embedded software, at a time calculated using random numbers or at a time calculated using the individual identification number.

The module version management unit 204 of the module providing server 2 confirms, through the individual information management unit 206, that the individual identification number of the home network server 1 that has sent the software configuration information is registered in the individual information database 302. Thereafter, the module version management unit 204 executes a process of creating update list information (step S112). In step S112, the module version management unit 204 determines whether each of the program modules designated by the software configuration information is a latest one, on the basis of the software configuration information reported from the home network server 1 and the module management database 301. If the program module group reported by the software configuration information includes one that is not latest, the module version management unit 204 creates update list information that indicates a latest program module, which can be installed in the home network server 1, and a dependence module that is associated with the latest program module. FIG. 9 shows an example of the update list information. Because of the dependency relationship between program modules, there may be a case where constraints are imposed on the order of installing such program modules. For example, in order to update the module C, the module B needs to be updated at first. In order to update the module B, the module A needs to be updated in advance. In this case, information indicative of the order of installation is added to the update list information, as shown in FIG. 9. Instead of the information indicative of the order of installation, dependency relationship information may be added to the update list information. The dependency relationship information indicates that the dependence module associated with the module C is the module B, and the dependence module associated with the module B is the module A.

The module version information delivery unit 205 of the module providing server 2 sends the update list information, which is created by the module version management unit 204, to the home network server 1 that has sent the software configuration information (step S113).

Upon receiving the update list information, the module information acquisition unit 104 of the home network server 1 displays an update notice dialog, as shown in FIG. 10, on the operation screen using the user notice unit 102. Thereby, the user is informed of the presence of a version-updated program (step S114). The update notice dialog comprises a message indicative of the completion of preparation for version updating, a “DETAIL” button 401, and a “CANCEL” button 402. The “DETAIL” button 401 is a button for displaying a list of latest modules. The “CANCEL” button 402 is a button for finishing the automatic updating process.

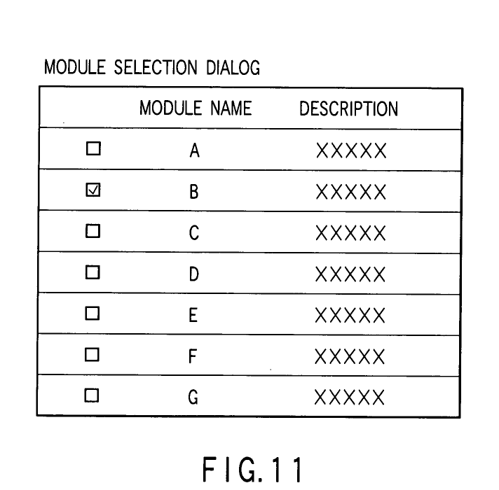

If the “DETAIL” button 401 is pressed by the user, the user notice unit 102 displays, based on the update list information, a module selection dialog, as shown in FIG. 11, that indicates a list of latest modules (step S115). The module selection dialog shows the module name of each program module, which is included in the update list information, and a description of each program module. The module selection dialog may display all modules (including dependence modules) designated by the update list information, but it may show only a list of version-updated latest program modules, while omitting indication of dependence modules. In addition, the module selection dialog shows check boxes in association with the program modules included in the update list information. A program module, with respect to which a check mark is put in the associated check box, is selected as a to-be-downloaded program module.

The module acquisition unit 104 prepares a download list for downloading program modules selected on the module selection dialog, and dependence modules associated with the selected program modules (step S116). The process for preparing the download list is executed according to a procedure illustrated in the flow chart of FIG. 7. Specifically, if a program module is selected on the module selection dialog, the module acquisition unit 104 adds the module name of the selected program module to the download list (step S131, S132). Then, the module acquisition unit 104 determines whether there are dependence modules associated with the selected program modules (i.e. whether dependency modules are necessary in order to execute the selected program modules), based on the dependency relationship information included in the update list information or the information indicative of the order of installation, which is included in the update list information (step S133). If there are such dependence modules (YES in step S133), the module acquisition unit 104 adds the module name of the dependence module associated with the selected program module to the download list (step S134).

According to the prepared download list, the module acquisition unit 104 downloads the program module group from the module providing server 2 (step S117). In step S117, the module acquisition unit 104 transmits to the module providing server 2 an acquisition request for each of the program modules registered on the download list, along with the individual identification number of the home network server 1. The module delivery unit 203 of the module providing server 2 transmits to the home network server 1 the program modules designated by the acquisition request. If the program modules are downloaded to the home network server 1 from the module providing server 2, the home network server 1 notifies the module providing server 2 of the completion of download. Upon receiving the notification, the module providing server 2 sets, using the individual information management unit 206, the update flag indicative of “failure” within the individual information management database 302 corresponding to each program module that is downloaded to the home network server 1.

As has been described above, the home network server 1 determines the to-be-downloaded program modules, referring to the update list information that is sent from the module providing server 2. The update list information indicates the latest program modules and the dependence modules corresponding to the latest program modules. Thereby, no matter which of program modules are selected by the user, it is possible to automatically download from the module providing server 2 not only the selected program modules but also the dependence modules associated with the selected program modules.

After the program module group is downloaded, the module update processing unit 105 detects, using the process management unit 106, a non-operative time period of the application program that is included in the embedded software (step S118). The module update processing unit 118 executes the updating process for updating the embedded software using the downloaded program modules, during the detected non-operative time period, that is, during an idle time period in which the application program is not executed (steps S119 and S120). If the application program is not currently executed and execution of the application program is not scheduled within a predetermined time period from the current time point, the updating process is immediately executed. In the updating process in step S120, the downloaded program module group is installed in the hard disk drive 19. In this case, the already installed old-version program modules are updated using the latest-version program modules. In this embodiment, the updating process is executed during the non-operative time period of the application program. Thus, the program modules of the application program can normally be updated without abnormally finishing the application program.

If the updating process is successfully executed (YES in step S121), the module update processing unit 105 informs the module providing server 2 of the successful execution of the updating process (step S122). In step S122, the module updating process unit 118 informs the module providing server 2 of the module name and version number of each of the successfully updated program modules. The module providing server 2 changes the associated update flag in the individual information management database 302 to “success.” On the other hand, if the updating process fails (NO in step S121), the module update processing unit 105 displays an error message on the operation screen through the user interface 16 (step S123).

As is indicated by a broken line in FIG. 5, the process of steps S114 to S116 may be skipped. In this case, the module acquisition unit 104 automatically selects, as to-be-downloaded modules, all the program modules designated by the update list information that is sent from the module providing server 2, and downloads all the program modules from the module providing server 2 (step S117). It is preferable, for example, to prepare in advance an automatic update mode and a user select mode. When the automatic update mode is preselected by the user, the CPU 17 of home network server 1 skips the process of steps S114 to S116. When the user select mode is preselected by the user, the CPU 17 of home network server 1 executes the process of steps S114 to S116.

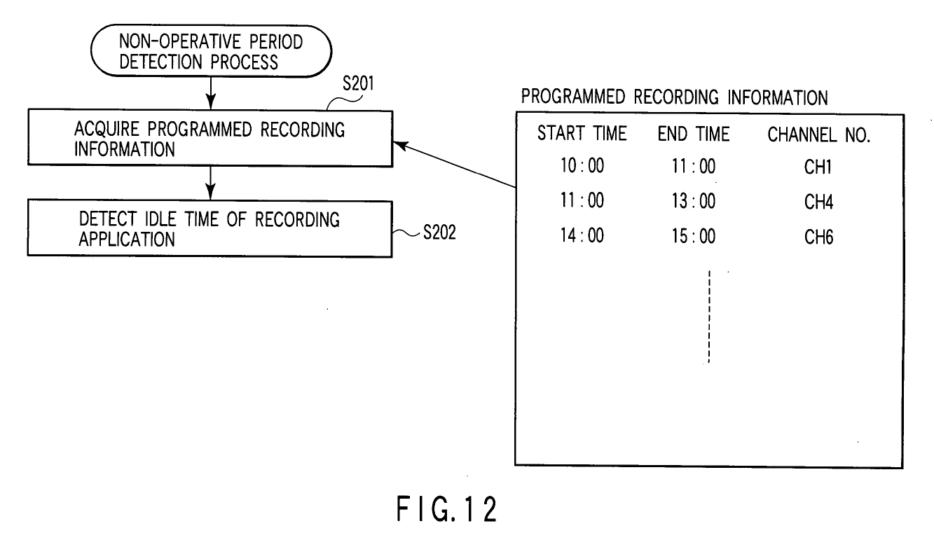

Next, an example of the non-operative time period detection process is described referring to FIG. 12.

In the home network server 1, a recording application program is preinstalled. The recording application program executes a recording process in which broadcast program data that is designated by programmed recording information is recorded. The programmed recording information is indicative of a recording start time, a recording end time and a channel number for recording, for each of TV broadcast programs that are programmed by the user. According to the programmed recording information, the process management unit 106 controls the start and end of the recording application program.

The module update processing unit 105 acquires programmed recording information (step S201). Based on the programmed recording information, the module update processing unit 105 recognizes the schedule of execution of the recording application program, thereby detecting a non-execution time period of the recording application program, that is, an idle time period of the recording process (step S202). In step S202, for example, an idle time period of a predetermined duration (e.g. 30 minutes), which comes earliest from the completion of the download of all program modules, is detected. In the example of FIG. 12, if download of the program module group is completed at 10:00, the update process (installation) for the embedded software is executed making use of the idle time between 13:00 and 14:00.

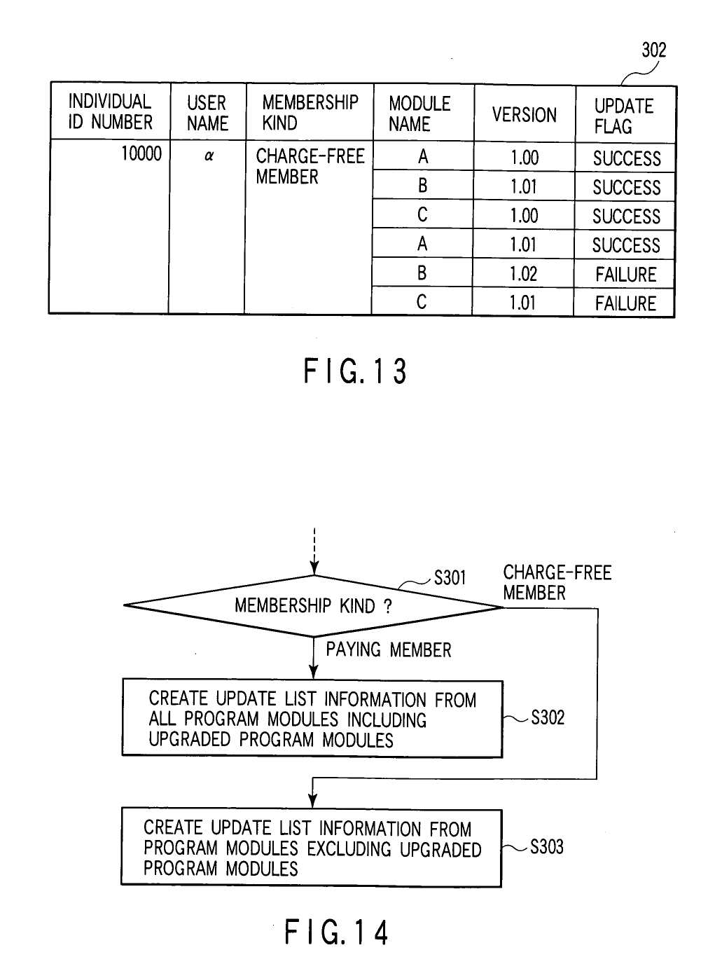

FIG. 13 shows another example of the individual information management database 302.

In this example, two attributes, the user name and membership kind, are added to the individual information management database 302. The membership kinds include, e.g. a regular member (paying member) and a non-regular member (charge-free member). The module version management unit 204 of module providing server 2 has a function of making the kind of to-be-delivered program modules different between regular-membership users (paying members) and non-regular-membership users (charge-free members). For example, program modules (updated package) in which bugs, etc. are corrected and program modules (upgraded package) in which new functions are added are delivered to the regular-membership users (paying members). On the other hand, only the updated package is delivered to the non-regular-membership users (charge-free members), and the upgraded package is not delivered to them.

Upon receiving an update list information acquisition request including software configuration information from the home network server 1, the module version management unit 204 of the module providing server 2 determines, using the individual information management unit 206, whether the user of the home network server 1 that has sent the update list information acquisition request is a regular member (paying member) or a non-regular member (charge-free member (step S301). In step S301, on the basis of the individual identification number included in the update list information acquisition request sent from the home network server 1, the module version management unit 204 inquires of the individual information management unit 206 about the membership kind of the user of the home network server 1. Thereby, the module version management unit 204 is able to determine whether the user of the home network server 1 is a regular member (paying member) or a non-regular member (charge-free member.

If the user of the home network server 1 is a regular member (paying member), the module version management unit 204 creates update list information on the basis of the version number of each of all program modules including upgraded program modules, which are stored in the module storing unit 202, and the version number of each of program modules, which are designated by the software configuration information that is reported from the home network server 1 (step S302).

On the other hand, if the user of the home network server 1 is a non-regular member (charge-free member), the module version management unit 204 creates update list information on the basis of the version number of each of the program modules excluding upgraded program modules, which are stored in the module storing unit 202, and the version number of each of program modules, which are designated by the software configuration information that is reported from the home network server 1 (step S303).

Through the above-described process, the kind of to-be-delivered program modules can be varied according to the membership kind of the user.

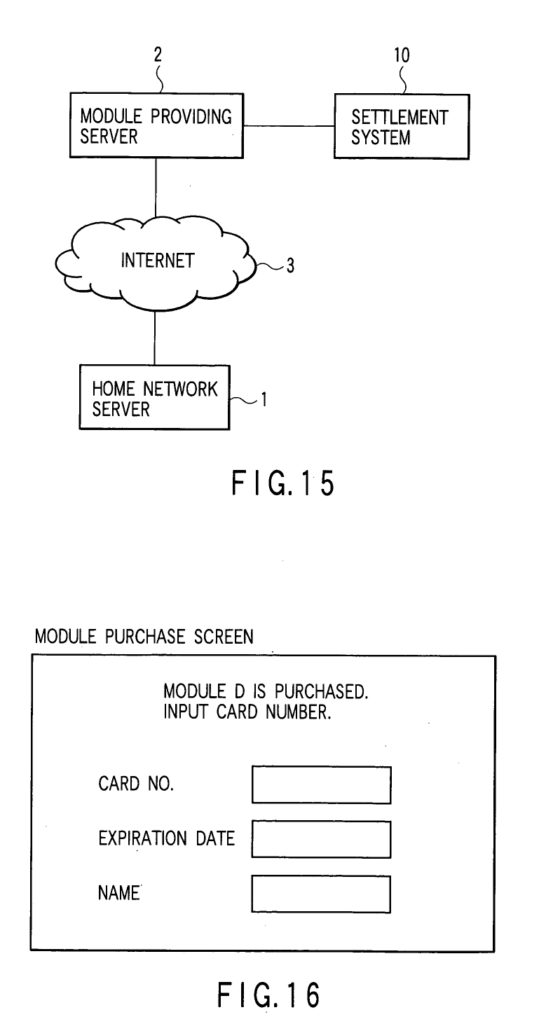

In the meantime, pay program modules may be delivered from the module providing server 2 to the home network server 1. In this case, as shown in FIG. 15, it is preferable to use a settlement system 10 that is capable of communicating with the module providing server 2. In a case where to-be-delivered program modules include pay program modules, the home network server 1 displays a module purchase screen as shown in FIG. 16 on the operation screen through the user interface unit 16. Settlement information, such as a credit card number, an expiration date and a user name, which is input by the user through the module purchase screen, is sent from the home network server 1 to the module providing server 2. In order to execute the settlement process, the module providing server 2 transmits the settlement information to the settlement system 10. If the settlement is normally completed, pay program modules are delivered from the module providing server 2 to the home network server 1.

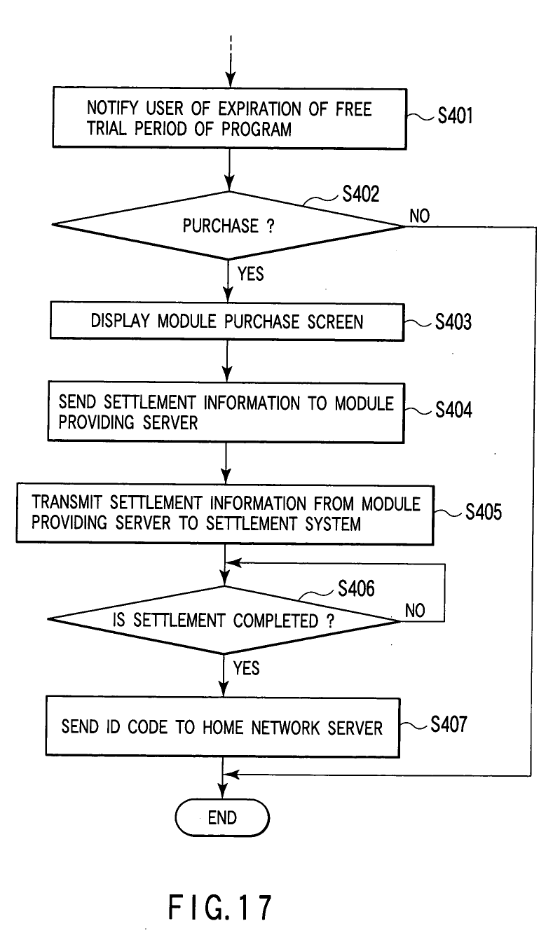

Referring to a flow chart of FIG. 17, an example of a specific process procedure for providing pay program modules is described. Assume that a program module that is free in a trial period and becomes charged after the expiration of the trial period (hereinafter referred to as “expiration-date-added program module”) is provided.

An expiration-date-added program module is installed in the home network server 1. If the trial period of the expiration-date-added program module expires, the CPU 17 of the home network server 1 displays a purchase button and a message indicative of the expiration, on the operation screen through the user interface unit 16, thereby notifying the user that the trial period of the expiration-date-added program module has expired (step S401). If the user presses the purchase button (YES in step S402), the CPU 17 displays the module purchase screen as shown in FIG. 16 on the operation screen through the user interface unit 16 (step S403).

If the settlement information, such as a credit card number, an expiration date and a user name, is input by the user through the module purchase screen, the CPU 17 sends the input settlement information to the module providing server 2 (step S404). The module providing server 2 transmits the settlement information, which is received from the home network server 1, to the settlement system 10, and requests that the settlement system 10 execute the settlement process (step S405). If the settlement process is normally completed (YES in step S406), the module providing server 2 sends to the home network server 1 an ID code that is required for further continuous use of the expiration-date-added program module (step S406).

At a time of registering membership, for example, the settlement information that is input by the user of the home network server 1 may be prestored in the module providing server 2. In this case, the membership ID and password may be input as the settlement information through the module purchase screen.

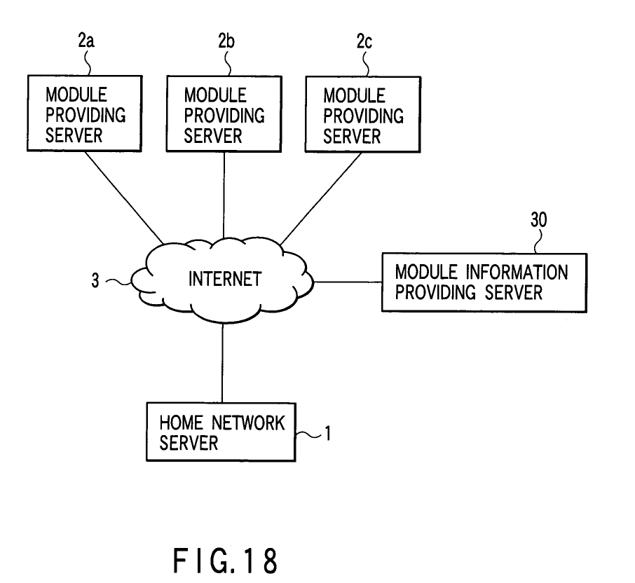

Next, referring to FIG. 18, a description is given of an example of decentralized management of program modules with use of a plurality of module providing servers.

New-version program module groups are stored in module providing servers 2a, 2b and 2c in a distributed fashion. A module information providing server 30 manages which of the program module groups is present in which of the module providing servers. To the module information providing server 30, the home network server 1 periodically transmits, as an update list information acquisition request, the individual identification number and the version information indicative of the version number of each of the current program modules that constitute the embedded software. Thereby, the home network server 1 requests update list information from the module information providing server 30. The module information providing server 30 creates update list information that indicates latest program modules that can be installed in the home network server 1 and dependence modules that are associated with the latest program modules. The update list information further includes server information that designates module providing servers in which respective program modules are stored. The home network server 1 downloads a to-be-downloaded program module from a module providing server that is designated by server information corresponding to the to-be-downloaded program module. Thereby, a load can be distributed among the module providing servers 2a, 2b and 2c.

As has been described above, according to the present embodiment, it is possible to automatically download from the module providing server 2 not only the program modules selected by the user but also other program modules that are necessary for executing the selected program modules. In addition, in the automatic update mode, all the program modules designated by the update list information can automatically be downloaded from the module providing server 2 without a selection operation by the user.

Communication between the home network server 1 and module providing server 2 may be encrypted using SSL (Secure Sockets Layer), etc.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An electronic apparatus capable of executing communication with a serer via a network, the electronic apparatus comprising:
a informing unit configured to inform the server of software configuration information indicative of a current configuration of embedded software that is installed in the electronic apparatus, to request update list information from the server, the update list information indicating of a latest program module that can be installed in the electronic apparatus and another program module that is necessary for execution of the latest program module;
a downloading unit configured to download from the server a plurality of program modules including the latest program module and said another program module, based on the update list information that is transmitted from the server; and
an updating unit configured to execute an updating process for updating the embedded software, using said downloaded plurality of program modules.

2. The electronic apparatus according to claim 1, further comprising:
a display device to display a list of latest program modules that can be installed in the electronic apparatus, based on the update list information; and
a determining unit configured to determine, when a program module to be downloaded is selected from the list of the latest program modules, that a program module group including the selected program module and another program module necessary for execution of the selected program module is a program module group that is to be downloaded, based on the update list information,
wherein the downloading unit is configured to download the determined program module group from the server.

3. The electronic apparatus according to claim 1, wherein the updating unit includes a detecting unit configured to detect a non-operative period of an application program that is included in the embedded software, and a executing unit configured to execute the updating process during the detected non-operative period.

4. The electronic apparatus according to claim 1, wherein the embedded software includes an application program that executes a recording process for recording broadcast program data that is designated by programmed recording information, and
the updating unit includes:
a detecting unit configured to detect a non-operative period of the application program based on the programmed recording information; and
a executing unit configured to execute the updating process during the detected non-operative period.

5. A method for updating embedded software that is installed in an electronic apparatus capable of executing communication with a serer via a network, the method comprising:
informing the server of software configuration information indicative of a current configuration of embedded software that is installed in the electronic apparatus;
transmitting update list information from the server to the electronic apparatus, the update list information indicating of a latest program module that can be installed in the electronic apparatus and another program module that is necessary for execution of the latest program module;
downloading from the server a plurality of program modules including the latest program module and said another program module, based on the update list information that is transmitted from the server; and
executing an updating process for updating the embedded software, using said downloaded plurality of program modules.

6. The method according to claim 5, further comprising:
displaying a list of latest program modules that can be installed in the electronic apparatus, based on the update list information; and
determining, when a program module to be downloaded is selected from the displayed list of the latest program modules by a user of the electronic apparatus, that a program module group including the selected program module and another program module necessary for execution of the selected program module is a program module group that is to be downloaded, based on the update list information,
wherein the downloading downloads the determined program module group from the server.

7. The method according to claim 5, wherein the executing includes detecting a non-operative period of an application program that is included in the embedded software, and executing the updating process during the detected non-operative period.

8. The method according to claim 5, wherein the embedded software includes an application program that executes a recording process for recording broadcast program data that is designated by programmed recording information, and
the executing includes:
detecting a non-operative period of the application program based on the programmed recording information; and
executing the updating process during the detected non-operative period.

9. The method according to claim 5, wherein the transmitting includes:
determining whether a user of the electronic apparatus is a regular member or not;
transmitting, if the user of the electronic apparatus is the regular member, update list information that is indicative of a latest program module and another program module necessary for execution of the latest program module from the saver to the electronic apparatus, based on a version number of each of all program modules including upgraded program modules, which are stored in the server, and a version number of each of program modules, which are designated by the software configuration information; and
transmitting, if the user of the electronic apparatus is not the regular member, update list information that is indicative of a latest program module and another program module necessary for execution of the latest program module from the saver to the electronic apparatus, based on the version number of each of all program modules excluding the upgraded program modules, which are stored in the server, and the version number of each of program modules, which are designated by the software configuration information.

10. An electronic apparatus capable of executing communication with a serer via a network, the electronic apparatus comprising:
means for informing the server of software configuration information indicative of a current configuration of embedded software that is installed in the electronic apparatus, to request update list information from the server, the update list information indicating of a latest program module that can be installed in the electronic apparatus and another program module that is necessary for execution of the latest program module;
means for downloading from the server a plurality of program modules including the latest program module and said another program module, based on the update list information that is transmitted from the server; and
means for executing an updating process for updating the embedded software, using said downloaded plurality of program modules.

11. The electronic apparatus according to claim 1, further comprising:
means for displaying a list of latest program modules that can be installed in the electronic apparatus, based on the update list information; and
means for determining, when a program module to be downloaded is selected from the list of the latest program modules, that a program module group including the selected program module and another program module necessary for execution of the selected program module is a program module group that is to be downloaded, based on the update list information,
wherein the means for downloading includes means for downloading the determined program module group from the server.

12. The electronic apparatus according to claim 10, wherein the means for executing the updating process includes means for detecting a non-operative period of an application program that is included in the embedded software, and means for executing the updating process during the detected non-operative period.

13. The electronic apparatus according to claim 10, wherein the embedded software includes an application program that executes a recording process for recording broadcast program data that is designated by programmed recording information, and
the means for executing the updating process includes:
means for detecting a non-operative period of the application program based on the programmed recording information; and
means for executing the updating process during the detected non-operative period.
